(19) United States
(12) Patent Application Publication
(10) Pub. No.: US 2003/0044070 A1
(43) Pub. Date: Mar. 6, 2003

(54) Method for the automatic detection of red-eye defects in photographic image data

(76) Inventors: Manfred Fuersich, Taufkirchen (DE); Guenter Meckes, Muenchen (DE)

Correspondence Address: Karl F. Milde, Jr., Esq., MILDE & HOFFBERG, L.L.P., Suite 460, 10 Bank Street, White Plain, NY, 10606, US

(21) Appl. No.: 10/192,714

(22) Filed: Jul. 9, 2002

(30) Foreign Application Priority Data
Sep. 3, 2001 (EP) 01121104.2

(51) Int. Cl. G06K 9/46; G06K 9/00; G06K 9/62

(52) U.S. Cl. 382/190; 382/209; 382/218; 382/203; 382/118; 382/199

(57) ABSTRACT

In a method for the automatic detection of red-eye defects in photographic image data, one processing stage comprises an object recognition process that finds faces in image data based on density progressions that are typical for such faces.

### BACKGROUND OF THE INVENTION

The invention relates to a method for detecting red-eye defects in photographic image data.

Such methods are known from various electronic applications that deal with digital image processing.

Semi-automatic programs exist for the detection of red eyes, where the user has to mark the region that contains the red eyes on an image presented by a PC. The red error spots are then automatically detected and a corrective color that resembles the brightness of the eye is assigned and the correction is carried out automatically.

However, such methods are not suited for automatic photographic developing and printing machines, where many images have to be processed very quickly in succession, leaving no time to have each individual image viewed, and if necessary marked by the user.

For this reason, fully automatic methods have been developed for the use in automatic photographic developing and printing machines.

For example, EP 0,961,225 describes a program comprised of several steps for detecting red eyes in digital images. Initially, areas exhibiting skin tones are detected. In the next step, ellipses are fit into these detected regions with skin tones. Only those regions, where such ellipse areas can be fitted, will then be considered candidate regions for red eyes. Two red eye candidates are than sought within these regions, and their distance—as soon as determined—is compared to the distance of eyes. The areas around the red eye candidates that have been detected as potential eyes are now compared to eye templates to verify that they are indeed eyes. If these last two criteria are met as well, it is assumed that red eyes have been found. These red eyes are then corrected.

The disadvantage of this program is that often red dots in the image that are located in any skin-colored regions are recognized as red-eye defects as soon as structures that are similar to eyes are found around them.

### SUMMARY OF THE INVENTION

It is, therefore, a principal objective of the present invention to develop a method for the automatic detection of red eyes which operates as reliably as possible—that is, it finds red-eye defects reliably without detecting other details, as such defects, by mistake—and where the analysis of the image data is carried out in a time frame that is suitable for automatic photographic developing and printing machines.

This objective, as well as other objectives which will become apparent from the discussion that follows, are achieved, in accordance with the present invention, wherein one processing stage in the method for the automatic detection of red-eye defects comprises an object recognition process that finds faces in the image data based on density progressions that are typical for such faces.

Thus, according to the invention, the digitally present image data are subjected to an object recognition process that searches in the image data for faces based on density progressions that are typical for faces. For example, a density progression in the eye region that is characteristic for a face is a high negative density, that is, a bright area in the temple region, then a low density, that is, a dark area in the region of the first eye, then a density rising to a peak in the nose region, then again a reduced density similar to the one already achieved in the region of the second eye and then a rise to the high initial density in the region of the second temple. Area density progression can be used in the same manner as the line density progressions described above. Such object recognition methods are known from the field of people monitoring or identity control. Using such methods in the field of red-eye defect detection offers the possibility to integrate a very meaningful criterion, namely the presence of a face in the image data, into the defect detection process. This significantly increases the reliability of a red-eye defect detection method. Since such object recognition processes must typically operate in real time for person control, they are sufficiently fast to satisfy the requirements of photographic developing and printing machines.

It is advantageous to use only the gray scales of the image data when searching for a face using the object recognition process. Since only density progressions are being analyzed, it is entirely sufficient to use this reduced, non-color image data set in order to save computing time and capacity.

It is furthermore advantageous to reduce the resolution of the image data set before applying the object recognition process in order to apply these relatively computing-intensive algorithms to less data. This is to say that for a reliable recognition of faces, it is not necessary to analyze the high-resolution image data set that is required for a quality print or for the known red-eye detection methods.

An advantageously applicable object recognition process is the face recognition method that operates with flexible templates and is described in the report IS&T/SID Eighth Color Imaging Conference.

This method uses general sample faces, and enlarges or reduces them while comparing them in various positions with the image data to find similar structures in the compared gray scale images. A similarity value is determined at the point where the best agreement is found between one of the selected and altered sample faces and the density progressions in the image data. If the similarity value exceeds a certain threshold, one assumes that a face has been found in the image data. This method operates very reliably, however, it is relatively elaborate. Still, it can be used very well for smaller and slower photographic printing machines in the scope of a red-eye detection process. It can also be employed if prior to the application of this method images that reliably do not exhibit red-eye defects have already been ruled out based on other criteria, for example because they are black and white images or no flash has been used. Suitable for such exclusion methods switched in the incoming circuit are also various other criteria that are explained in the description of the figures.

Another advantageous object recognition method is the one described in IEEE Transactions on Computers, Vol. 42, No. 3, March 1993 that operates with a formable grid. With this method, formed standard grids of several reference faces are moved across the image data in any orientation. The density progression of the grid and image content is compared at the transformed locations and their surroundings by comparing the Fourier transformed signals of the standard grid junctions with the Fourier transformed signals of the image content at the image locations that correspond to the junctions. The grid is arrested and a similarity value is determined at that shape and position where the best agreement is found between the standard grid and the image content. If the similarity value exceeds a certain threshold, one again assumes that a face has been found in the image content according to the selected standard grid. This method operates very reliably as well, however, it is still comparatively computing time consuming. For this reason, it too lends itself to the use in slower copy machines or in detection processes where a pre-selection has already been made based on other criteria.

Also an advantageous method that can be used in the course of a red-eye detection process is the method published in the Journal of Electronic Imaging 9(2), 228-233 (April 2000), which is based on the use of eigenvectors. With this method, the matrix of all image data of the gray scale image is converted to a vector. Several eigenvectors are generated for this vector. These eigenvectors are compared to eigenvectors of standard faces generated by the same method.

A corresponding position in the image data is assumed from the eigenvector with the best agreement, and as soon as the agreement exceeds a certain degree, it is assumed that a face is located at this position. Due to the applied matrices and the vector computations, this method is also very computing time intensive, which may be compensated for, as with the other methods, by increasing the computing capacity.

There are other advantageous face recognition methods that may be used here. For example, a histogram method generates line-by-line histograms of density progression images of the image data and compares these to histograms of model faces. However, this method has the disadvantage that only faces with a certain orientation can be found, unless model faces with orientation in other directions are provided. Another known method operates with neural networks. The entire coarsely rastered image data set is read into these networks and evaluated using the neural network. Since the network has learned how images with a face appear, one assumes that it can evaluate, whether a new image contains a face or not. Here too gray scale images are preferably used in order to save computing time. However, this method is less dependable as the previously mentioned methods. However, if it is important to employ a fast method and dependability is not as important a factor, this method may be used as well. Other such methods that all may be used within the scope of the invention, provided they work with gray scales and not with the full multi-color data set, are published in the respective literature. The color data set may be used to clarify at the outset, whether persons are even in the photo based on the search for skin tones. It is prudent to look for red-eye defects, and therefore for faces, only in images where a pre-analysis has determined that persons are in the photograph, especially when such elaborate face recognition methods are used.

In one advantageous embodiment of the method according to the invention, the object recognition process is used to search for faces in all or in pre-selected images in order to have a reliable criterion or prerequisite for the occurrence of red-eye defects available. If a face is found in the image data and if other criteria for the presence of red-eye defects are met, such as the presence of a flash photograph, red spots in the image red/white combinations, high contrasts, etc., one can assume that red-eye defects need to be corrected.

An advantageous method for analyzing criteria for the presence of red-eye defects is to search for faces in the image data using an object recognition process, and if faces are present to look for red spots at the automatically specified eye positions, and to possibly analyze other criteria such as the use of a flash when taking the picture in order to rule out erroneous assumptions.

An additional advantageous method to utilize an object recognition process as part of a method for detecting redeye defects is to use it as an additional criterion independent of other criteria for the presence of red-eye defects, in order to analyze whether faces are present in the image data set. By analyzing several different criteria independent of one another, it can be avoided that the red-eye detection process is terminated as soon as one criterion is erroneously determined as being not present. This increases the reliability of the method. Although the method can be carried out if indications and prerequisites are only classified as either present or not present, it is more accurate to determine probabilities for the presence, since most of the indications or prerequisites cannot be analyzed as one hundred percent given or not given. Determining probabilities opens the possibility to enter into the final evaluation a decision of how reliable an indication or a prerequisite could be determined or not. Thus, in addition to the presence of indications and prerequisites, an additional criterion, namely the reliability or unreliability of this determination, enters into the evaluation as well, which leads to a much more accurate overall result. In the overall evaluation, an overall probability can be determined from the individual probabilities, where said overall probability becomes a measure, whether red-eye defects are present or not by comparison with a threshold.

Furthermore, it is very advantageous to enter the determined values of the presence of indications or prerequisites with a weighting into the overall evaluation. In this manner, it is possible, for example, to categorize the indications and prerequisites into those that are very relevant for the determination of red-eye defects, into those that are a good indication or prerequisite but may not always be present, and into those that occur only occasionally. The fact that these differently categorized indications and prerequisites enter the evaluation in a weighted manner accommodates their relevance, which in turn enhances the accuracy of the decision.

It is particularly advantageous to allow the values for the overall evaluation that have been determined independently of one another for the presence of indications and prerequisites to flow into a neural network. Within a neural network, a weighting of the criteria occurs automatically, although it advantageously is carried out during a learning phase of the network using exemplary images. Both the combination of the values for an overall evaluation and the decision, whether potential or actual red-eye defects are present, can be transferred to the neural network. Either binary data—that is, the determination “indications or prerequisites present” or “not present”—or probabilities for the presence of indications or prerequisites can be entered as values in the neural network. However, any other form of valuation of the presence, for example a categorization into “not present”, “probably not present”, “probably present” or “definitely present” can be imagined as well. All possible imaginable valuations can be used for determining the values.

In a particularly advantageous embodiment of the method, indications or prerequisites such as the use of a flash or the presence of faces are analyzed in the image simultaneously. Investigating image or recording data simultaneously for indications or prerequisites can save much computing time. This is possibly the fact that allows this method to be used in photographic developing and printing machines of large-scale laboratories, because these units need to process several thousand images in an hour.

Still, investigating image data for the presence of red-eye defects is always a computing time intensive method. It is, therefore, particularly advantageous to connect in the incoming circuit of the method for detecting a red-eye defect, and regardless to what manner the object recognition process is being used, a check of the image or recording data for exclusion criteria. Such exclusion criteria serve the purpose of ruling out red-eye defects from the outset, thus automatically terminating the process for detecting red-eye defects. This can save a tremendous amount of computing time. Such exclusion criteria may be, for example, the existence of pictures where definitely no flash has been used, or the absence of any larger areas with skin tones, or a strong drop of Fourier transformed signals of the image data, which points to the absence of any detail information in the image—that is, a fully homogeneous image. Any other criteria that are used for red-eye detection, can be checked quickly and can with great reliability rule out images without red-eye defects, are suitable as exclusion criteria. The fact that no red or no color tones at all are present in the entire image information can also be an exclusion criterion.

A particularly significant criterion that—as already mentioned—serves as an exclusion criterion and as a prerequisite for the presence of red-eye defects, is the use of a flash when taking pictures. This is a very reliable criterion, since red-eye defects occur only in images, when taking a picture of a person and the flash is reflected in the fundus (background) of the eye. However, the absence of a flash in an image can only be determined directly if the camera sets so-called flash markers when taking the picture. APS or digital cameras are capable of setting such markers that indicate whether a flash has been used or not. If a flash marker has been set that signifies that no flash has been used when taking the picture, it can be assumed with great reliability that no red-eye defects occur in the image.

With the majority of images having no such flash markers set, it can be concluded only indirectly, whether a flash picture is present or not. This can be determined, for example, by using an image analysis. In such an analysis, one may look for strong shadows of persons on the background, where the outline of the shadow corresponds to that of the outline of the face, but where the area exhibits a different color or image density. As soon as such very dominant hard shadows are present, it can be assumed with great probability that a flash has been used when taking the picture.

When it is determined that the image is very poor in contrasts, it is an indication that no flash has been used when taking the picture. The determination that the image is an artificial light image—that is, an image that exhibits the typical colors of lighting of an incandescent lamp or a fluorescent lamp—also indicates that no or no dominant flash has been used. A portion of the analysis that is carried out to determine if a flash has been used or not can already be done based on the so-called pre-scan data (the data arising from pre-scanning). Typically, when scanning photographic presentations, a pre-scan is performed prior to the actual scanning that provides the image data. This pre-scan determines a selection of the image data in a much lower resolution. Essentially, these pre-scan data are used to optimally set the sensitivity of the recording sensor for the main scan. However, they also offer, for example, the possibility to determine the existence of an artificial light image or an image poor in contrasts, etc.

These low-resolution data lend themselves to the analysis of the exclusion criteria because their analysis does not require much time due to the small data set. If only one scan of the images is carried out or if only high-resolution digital data are present, it is advantageous to combine these data to low-resolution data for the purpose of checking the exclusion criteria. This can be done using an image raster, mean value generation or a pixel selection.

To increase the reliability of the assertion about the presence of a flash picture or the absence of a flash when the picture has been taken, it is advantageous to check several of the criteria mentioned here and to combine the results obtained when checking the individual criteria to an overall result and an assertion about the use of a flash. To save computing time, it is advantageous here as well to analyze the criteria simultaneously. The evaluation may be carried out using probabilities or a neural network as well.

Additional significant indications to be checked for the automatic detection of red-eye defects are adjacent skin tones. Although there will definitely be images that do not exhibit adjacent skin tones yet will have red-eye defects (e.g., when taking a picture of a face covered by a carnival mask), this indication may be used as an exclusion criterion to limit the pictures that are analyzed for red-eye defects if one accepts a few erroneous decisions.

However, it is particularly advantageous to check this criterion along with others in the image data and to enter them as one of many criteria into an overall evaluation. This would ensure that red-eye defects could be found even in carnival pictures, in pictures of persons with other skin tones or at a very colorful, dominant lighting, where the skin tones are altered. Although the indication “skin tone” is absent in such pictures, all other analyzed criteria could be determined with such high probability or so reliably that the overall evaluation indicates or suggests the presence of red-eye defects, even with the absence of skin tones. The method described in the state-of-the-art would, on the other hand, terminate the red-eye detection process due to the absence of skin tones, possibly resulting in an erroneous decision.

However, if skin tones are present in an image, it can be assumed that it is picture of a person, where the presence of red-eye defects are much more probable than in all other images. Thus, this criterion may be weighted more strongly. In particular, adjacent skin tones can be analyzed to see if they meet characteristics of a face—such as its shape and size—since with the probability of it being a face, the probability of there being red-eye defects increases as well. In this case, the criterion may be even more meaningful.

If the analysis of skin tones shall be used as an exclusion criterion, where in their absence red-eye defects are no longer sought, it is also sufficient to use the pre-scan data or corresponding data sets that are reduced in their resolution. If no skin tones appear in these low-resolution data, then reliably no large adjacent skin tone areas are present in the images. It may be sensible to forego the detection of red eyes in very small faces or in images that exhibit small faces in order to save computing time.

It is particularly advantageous to employ the object recognition process to verify artifacts that have been detected as potential red-eye defects. With this method, various criteria that point to the presence of red-eye defects are analyzed based on the image data in a red-eye detection process. If the result of the analysis of these criteria indicates with a great probability that red-eye defects are present, these potential red-eye candidates are recorded as potential eye positions. Using one of the described or known object recognition processes, the process will now try to find a face that fits the potential eye positions. If such a face is found, it can be assumed that the red-eye candidate is indeed a red-eye defect that must be corrected. However, if no face can be found whose eye position is defined by one of the red-eye candidates, it can be assumed that the red-eye candidates are other red image details and that these should not be corrected. To use the object recognition method only when red-eye candidates have been found in the image, has the great advantage that it is only employed with a very small number of images. Thus, only a relatively small number of images will be processed using this time intensive method, and, a fast processing of the total number of images to be developed and printed continues to be ensured. Thus, especially with very fast, large photographic printing machines, it is prudent to use an object recognition process only for the confirmation of potential red-eye candidates when such have already been detected in an image.

It is possible to save even more computing time by analyzing red-eye candidates for similarities and if the same characteristics are found, to combine them in pairs. By detecting a potential red-eye defect pair, only two orientations remain for the position of a sought face. This significantly limits the options that an object recognition process has to analyze, and the method can be carried out very quickly. The disadvantage is, though, that red-eye defects that occur in only one eye, such as in profile photographs, cannot be detected; however, since this is rather rare, this disadvantage may be acceptable for the sake of saving computing time. To detect the red-eye candidates that are to be verified, the methods described using the exemplary embodiment can be applied, however, methods such as the ones described in the aforementioned EP 0,961,225 for example, are suitable as well. Since the face finder provides a very reliable analysis of red-eye candidates, it is possible to reduce the accuracy of the methods for detecting the candidates. For example, it will often be sufficient, to analyze only a few criteria for red-eye defects without having to perform elaborate comparisons with eye templates or the like.

For a full understanding of the present invention, reference should now be made to the following detailed description of the preferred embodiments of the invention as illustrated in the accompanying drawing.

### BRIEF DESCRIPTION OF THE DRAWING

FIG. 1, comprised of FIGS. 1A, 1B and 1C, is a flowchart of an exemplary embodiment of the method according to the invention.

### DESCRIPTION OF THE PREFERRED EMBODIMENTS

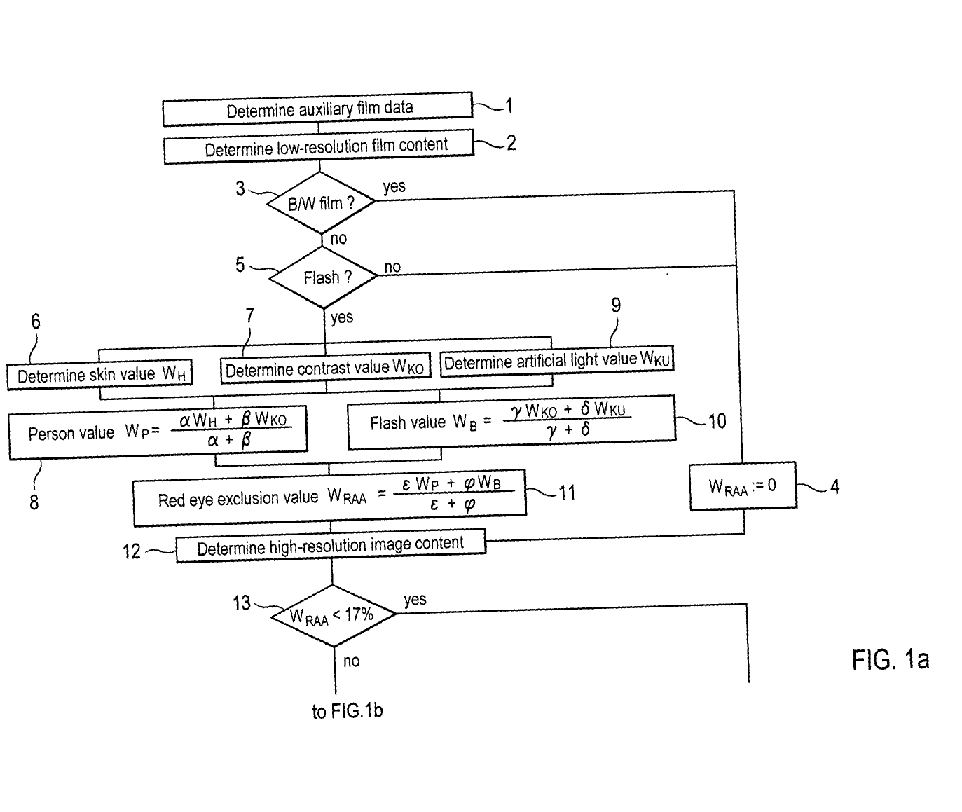

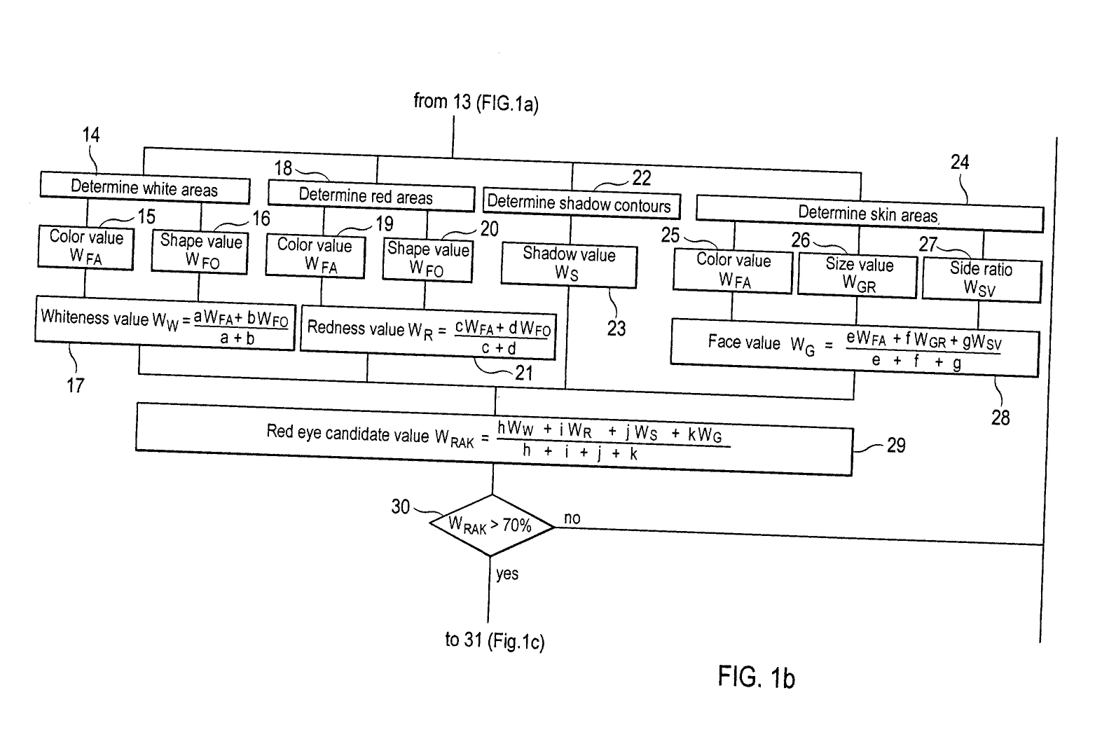

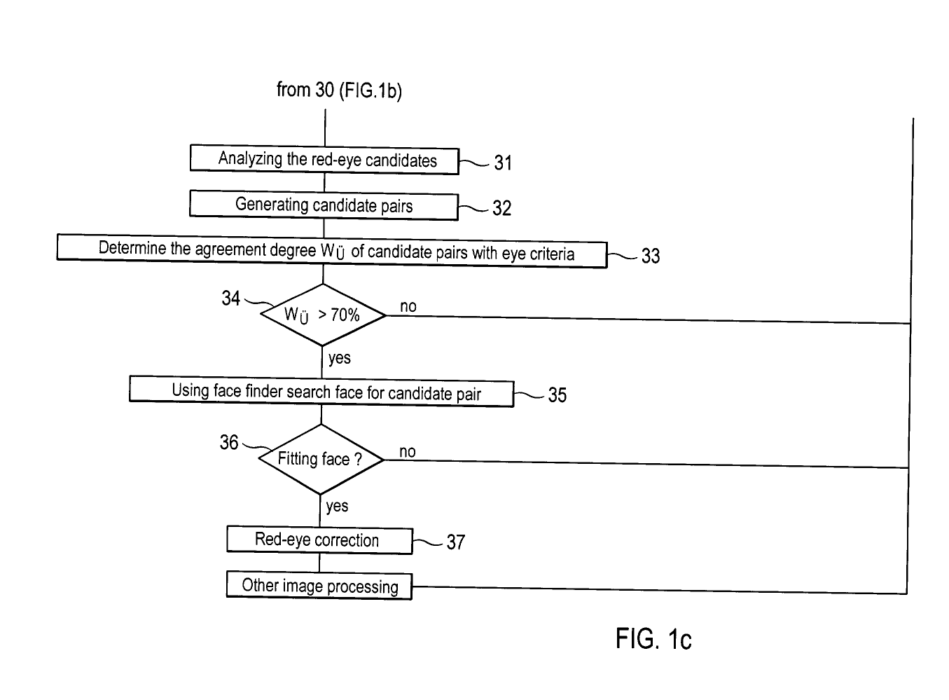

An advantageous exemplary embodiment of the invention will now be explained with reference to the flowchart of FIG. 1.

In order to analyze image data for red-eye defects, the image data must first be established using a scanning device, unless they already exist in a digital format, e.g., when coming from a digital camera. Using a scanner, it is generally advantageous to read out auxiliary film data such as the magnetic strip of an APS film using a low-resolution pre-scan and to determine the image content in a rough raster. Typically CCD lines are used for such pre-scans, where the auxiliary film data are either read out with the same CCD line that is used for the image content or are collected using a separate sensor. The auxiliary film data are determined in a step 1, however, they can also be determined simultaneously with the low-resolution film contents, which would otherwise be determined in a step 2. The low-resolution image data can also be collected in a high-resolution scan, where the high-resolution data set is then combined to a low-resolution data set. Combining the data can be done, for example, by generating a mean value across a certain amount of data or by taking only every x^{th} high-resolution image point for the low-resolution image set. Based on the auxiliary film data, a decision is made in a step 3 or in the first evaluation step, whether the film is a black and white film. If it is a black and white film, the red-eye detection process is terminated, the red-eye exclusion value W_{RAA} is set to Zero in a step 4, the high-resolution image data are determined, unless they are already present from a digital data set, and processing of the high-resolution image data is continued using additional designated image processing methods. The process continues in the same manner if a test step 5 determines that a flash marker is contained in the auxiliary film data that indicates that no flash has been used when taking the picture. As soon as such a flash marker has determined that no flash has been used when taking the picture, no red-eye defects can be present in the image data set. Thus, here too the red-eye exclusion value W_{RAA} is set to Zero, the high-resolution image data are determined, and other, additional image processing methods are started. Using the exclusion criteria “black and white film” and “no flash when taking picture”, which can be determined from the auxiliary film data, images that reliably cannot exhibit red-eye defects are excluded from the red-eye detection process. Much computing time can be saved by using such exclusion criteria because the subsequent elaborate red-eye detection method no longer needs to be applied to the excluded images.

Additional exclusion criteria that can be derived from the low-resolution image content are analyzed in the subsequent steps. For example, in a step 6, the skin value is determined from the low-resolution image data of the remaining images. To this end, skin tones that are an indication that persons are shown in the photo are sought in the image data using a very rough raster. The contrast value determined in a step 7 is an additional indication for persons in the photo. With an image that is very low in contrasts, it can also be assumed that no persons have been photographed. It is advantageous to combine the skin value and the contrast value to a person value in a step 8. It is useful to carry out a weighting of the exclusion values “skin value” and “contrast value”. For example, the skin value may have a greater weight than the contrast value in determining whether persons are present in the image. The correct weighting can be determined using several images, or it can be found by processing the values in a neural network.

The contrast value is combined with an artificial light value determined in step 9, which provides information whether artificial lighting—such as an incandescent lamp or a fluorescent lamp—is dominant in the image in order to obtain information whether the recording of the image data has been dominated by a camera flash. Contrast value and artificial light value generate a flash value in step 10.

If the person value and the flash value are very low, it can be assumed that no person is in the image and that no flash photo has been taken. Thus, the occurrence of red-eye defects in the image can be excluded. To this end, a red-eye exclusion value W_{RAA} is generated from the person value and the flash value in a step 11. It is not mandatory that the exclusion criteria “person value” and “flash value” be combined to a single exclusion value. They can also be viewed as separate exclusion criteria. Furthermore, it is imaginable to check other exclusion criteria that red-eye defects cannot be present in the image data.

When selecting the exclusion criteria, it is important to observe that checking these criteria must be possible based on low-resolution image data, because computing time can only be saved in a meaningful manner if very few image data can be analyzed very quickly to determine whether a red-eye detection method shall be applied at all or if such defects can be excluded from the outset. If checking the exclusion criteria were to be carried out using the high-resolution image data, the savings in computing time would not be sufficient to warrant checking additional criteria prior to the defect detection process. In this case, it would be more prudent to carry out a red-eye detection process for all photos. However, if the low-resolution image contents are used to check the exclusion criteria, the analysis can be done very quickly such that much computing time is saved, because the elaborate red-eye detection process based on the high-resolution data does not need to be carried out for each image.

If the image data are not yet present in digital format, the data of the high-resolution image content need now be determined from all images in a step 12. With photographic films, this is typically accomplished by scanning, using a high-resolution area CCD. However, it is also possible to use CCD lines or corresponding other sensors suitable for this purpose.

If the pre-analysis has determined that the red-eye exclusion value is very low, it can be assumed that no red-eye defects can be present in the image. The other image processing methods such as sharpening or contrast editing will be started without carrying out a red-eye detection process for the respective image. However, if in step 13 it is determined that red-eye defects cannot be excluded from the outset, the high-resolution image data will be analyzed to determine, whether certain prerequisites or indications for the presence of red-eye defects are at hand and the actual defect detection process will start.

It is advantageous that these prerequisites and/or indications are checked independent of one another. To save computing time, it is particularly advantageous to analyze them simultaneously. For example, in a step 14, the high-resolution image data are analyzed to determine, whether white areas can be found in them. A color value W_{FA} is determined for these white areas in a step 15, where said color value is a measure for how pure white these white areas are. In addition, a shape value W_{FO} is determined in step 16 that indicates, whether these found white areas can approximately correspond to the shape of a photographed eyeball or a light reflection in an eye or not. Color value and shape value are combined to a whiteness value in step 17, whereby a weighting of these values may be carried out as well. Simultaneously, red areas are determined in a step 18 that are assigned color and shape values as well in steps 19 and 20, respectively. From these, the redness value is determined in a step 21. The shape value for red areas refers to the question, whether the shape of the found red area corresponds approximately to the shape of a red-eye defect.

An additional, simultaneously carried out step 22 determines shadow outlines in the image data. This can be done, for example, by searching for parallel running contour lines whereby one of these lines is bright and the other is dark. Such dual contour lines are an indication that a light source is throwing a shadow. If the brightness/darkness difference is particularly great, it can be assumed that the light source producing the shadow was the flash of a camera. In this manner, the shadow value reflecting this fact and determined in a step 23 provides information, whether the probability for a flash is high or not.

The image data are analyzed for the occurrence of skin areas in an additional step 24. If skin areas are found, a color value—that is, a value that provides information how close the color of the skin area is to a skin tone color—is determined from these areas in a step 25. Simultaneously, a size value, which is a measure for the size of the skin area, is determined in a step 26. Also simultaneously, the side ratio, that is, the ratio of the long side of the skin area to its short side, is determined in a step 27. Color value, size value and side ratio are combined to a face value in a step 28, where said face value is a measure to determine how closely the determined skin area resembles a face in color size and shape.

Whiteness value, redness value, shadow value and face value are combined to a red-eye candidate value W_{RAK} in a step 29. It can be assumed that the presence of white areas, red areas, shadow outlines and skin areas in digital images indicates a good probability that the found red areas can be valued as red-eye candidates if their shape supports this assumption. When generating this value for a red-eye candidate, other conditions for the correlation of whiteness value, redness value and face value may be entered as well.

For example, a factor may be introduced that provides information, whether the red area and the white area are adjacent to one another or not. It may also be taken into account, whether the red and white areas are inside the determined skin area or are far away from it. These correlation factors can be integrated in the red-eye candidate value. An alternative to the determination of candidate values would be to feed color values, shape values, shadow value, size value, side ratio, etc. together with the correlation factors into a neural network and to obtain the red-eye candidate value from it.

Finally, the obtained red-eye candidate value is compared to a threshold in a step 30. If the value exceeds the threshold, it is assumed that red-eye candidates are present in the image. A step 31 then investigates, whether these red-eye candidates can indeed be red-eye defects. In this step, the red-eye candidates and their surroundings can, for example, be compared to the density profile of actual eyes in order to conclude, based on similarities, that the red-eye candidates are indeed located inside a photographed eye.

An additional option for analyzing the red-eye candidates is to search for two corresponding candidates with almost identical properties that belong to a pair of eyes. This can be done in a subsequent step 32 or as an alternative to step 31 or simultaneous to it. If this verification step is selected, only red-eye defects in faces photographed from the front can be detected. Profile shots with only one red eye will not be detected. However, since red-eye defects generally occur in frontal pictures, this error may be accepted to save computing time. If the criteria recommended in steps 31 and 32 are used for the analysis, a step 33 determines an agreement degree of the found candidate pairs with eye criteria. In step 34, the agreement degree is compared to a threshold in order to decide, whether the red-eye candidates are with a great degree of probability red-eye defects or not. If there is no great degree of agreement, it must be assumed that some other red image contents were found that are not to be corrected. In this case, processing of the image continues using other image processing algorithms without carrying out a red-eye correction.

However, if the degree of agreement of the candidates with eye criteria is relatively great, a face recognition process is applied to the digital image data in a subsequent step 35, where a face fitting to the candidate pair shall be sought. Building a pair from the candidates offers the advantage that the orientation of the possible face is already specified. The disadvantage is—as has already been mentioned—that the red-eye defects are not detected in profile photographs. If this error cannot be accepted, it is also possible to start a face recognition process for each red-eye candidate and to search for a potential face that fits this candidate. This requires more computing time but leads to a reliable result. If no face is found in a step 36 that fits the red-eye candidates, it must be assumed that the red-eye candidates are not defects, the red-eye correction process will not be applied and instead, other image processing algorithms are started. However, if a face can be determined that fits the red-eye candidates, it can be assumed that the red-eye candidates are indeed defects, which will be corrected using a typical correction process in a correction step 37. The previously described methods using density progressions may, for example, be used as a suitable face recognition method for the analysis of red-eye candidates. As a matter of principle, however, it is also possible to use simpler methods such as skin tone recognition and ellipses fits. However, these are more prone to errors.

There has thus been shown and described a novel method for the automatic detection of red-eye defects in photographic image data which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. In a method for the automatic detection of red-eye defects in photographic image data, the improvement wherein one processing stage of the method comprises an object recognition process that finds faces in image data based on density progressions that are typical for such faces.

2. Method as set forth in claim 1, wherein the object recognition process operates using gray scale images.

3. Method as set forth in claim 1, wherein the object recognition process is applied to an image data set that is reduced in its resolution, as compared to said photographic image data, in order to save computing time.

4. Method as set forth in claim 1, wherein face templates are used for the object recognition process.

5. Method as set forth in claim 1, wherein the object recognition process operates with formable grids.

6. Method as set forth in claim 1, wherein the object recognition process operates with eigenvectors.

7. Method as set forth in claim 1, wherein the object recognition comprises the step of determining a similarity value which is a measure for the similarity between specified model faces and actual content of the photographic image.

8. Method as set forth in claim 7, wherein the similarity value is used as a prerequisite for the occurrence of red-eye defects in the automatic detection method.

9. Method as set forth in claim 8, wherein the similarity value is linked together with other indications and/or prerequisites for the presence of red-eye defects in order to detect red-eye defects.

10. Method as set forth in claim 1, further comprising the step of determining the potential presence of red-eye defects, in dependence upon the outcome of the object recognition process.

11. Method as set forth in claim 10, wherein the object recognition process includes the step of searching for faces where a potential candidate for a red-eye defect is located, at a position of an eye within a face.

12. Method as set forth in claim 10, wherein similar, potential red-eye defects are combined in pairs.

13. Method as set forth in claim 12, wherein the object recognition process includes the step of searching for faces where potential red-eye defect pairs are located at an eye position.
